(19) United States
(12) Patent Application Publication
(10) Pub. No.: US 2025/0220544 A1
(43) Pub. Date: Jul. 3, 2025

(54) LOW LAYER TRIGGERED MOBILITY WITH SIDE INFORMATION

(71) Applicant: Samsung Electronics Co., Ltd., Suwon-si (KR)

(72) Inventors: Anum Ali, Frisco, TX (US); Vutha Va, Plano, TX (US); Priyabrata Parida, Dallas, TX (US); Yuqiang Heng, Plano, TX (US); Boon Loong Ng, Plano, TX (US)

(21) Appl. No.: 18/654,674

(22) Filed: May 3, 2024

Related U.S. Application Data
(60) Provisional application No. 63/615,014, filed on Dec. 27, 2023.

(51) Int. Cl. H04W 36/32; H04W 36/00; H04W 36/18

(52) U.S. Cl. CPC H04W 36/324; H04W 36/00835; H04W 36/18; H04W 36/322

(57) ABSTRACT

A user equipment (UE) includes a transceiver configured to receive a configuration message including a plurality of candidate cells for low layer triggered mobility (LTM) handover (HO). The UE further includes a processor operatively coupled to the transceiver. The processor is configured to determine, based on side information and the plurality of candidate cells, a plurality of cells for performing early-sync, and perform early-sync with the determined plurality of cells for performing early-sync. The transceiver is further configured to receive a message including a command to perform an LTM HO to a target cell. The processer is further configured to perform the LTM HO to the target cell, and update the side information based on the LTM HO.

### CROSS-REFERENCE TO RELATED APPLICATION AND CLAIM OF PRIORITY

This application claims priority under 35 U.S.C. § 119 (e) to U.S. Provisional Patent Application No. 63/615,014 filed on Dec. 27, 2023. The above-identified provisional patent application is hereby incorporated by reference in its entirety.

### TECHNICAL FIELD

This disclosure relates generally to wireless networks. More specifically, this disclosure relates to apparatuses and methods for low layer triggered mobility with side information.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for low layer triggered mobility with side information.

In one embodiment, a user equipment (UE) is provided. The UE includes a transceiver configured to receive a configuration message including a plurality of candidate cells for low layer triggered mobility (LTM) handover (HO). The UE further includes a processor operatively coupled to the transceiver. The processor is configured to determine, based on side information and the plurality of candidate cells, a plurality of cells for performing early-sync, and perform early-sync with the determined plurality of cells for performing early-sync. The transceiver is further configured to receive a message including a command to perform an LTM HO to a target cell. The processer is further configured to perform the LTM HO to the target cell, and update the side information based on the LTM HO.

In another embodiment, a method of operating a UE is provided. The method includes receiving a configuration message including a plurality of candidate cells for LTM HO, determining, based on side information and the plurality of candidate cells, a plurality of cells for performing early-sync, and performing early-sync with the determined plurality of cells for performing early-sync. The method further includes receiving a message including a command to perform an LTM HO to a target cell, performing the LTM HO to the target cell, and updating the side information based on the LTM HO.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example procedure for baseline handover according to embodiments of the present disclosure;

FIG. 5 illustrates an example procedure for LTM handover according to embodiments of the present disclosure;

FIG. 6 illustrates an example procedure for LTM handover with side information according to embodiments of the present disclosure;

FIG. 7 illustrates an example procedure for updating a configuration in an intelligent mobility module according to embodiments of the present disclosure;

FIG. 8 illustrates an example procedure for location based candidate cell early-sync selection according to embodiments of the present disclosure;

FIG. 9 illustrates another example procedure for location based candidate cell early-sync selection according to embodiments of the present disclosure;

FIG. 10 illustrates another example procedure for location based candidate cell early-sync selection according to embodiments of the present disclosure;

FIG. 11 illustrates another example procedure for location based candidate cell early-sync selection according to embodiments of the present disclosure;

FIG. 12 illustrates an example procedure for location based layer 1 filtering according to embodiments of the present disclosure;

FIG. 13 illustrates an example procedure for traffic based candidate cell early-sync selection according to embodiments of the present disclosure;

FIG. 14 illustrates an example procedure for RAT based threshold selection according to embodiments of the present disclosure;

FIG. 15 illustrates another example procedure for RAT based threshold selection according to embodiments of the present disclosure;

FIG. 16 illustrates another example procedure for RAT based threshold selection according to embodiments of the present disclosure;

FIG. 17 illustrates another example procedure for RAT based threshold selection according to embodiments of the present disclosure;

FIG. 18 illustrates an example procedure for multi-factor based candidate cell early-sync selection according to embodiments of the present disclosure; and

FIG. 19 illustrates a method for low layer triggered mobility with side information according to embodiments of the present disclosure.

### DETAILED DESCRIPTION

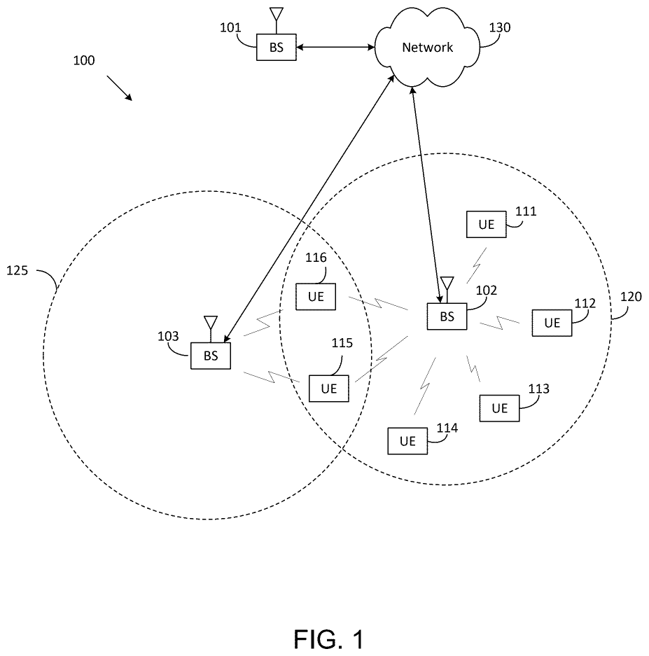

FIGS. 1 through 19, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz, 39 GHz, or 60 GHz bands, so as to accomplish higher data rates or in lower frequency bands, such as sub-6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for low layer triggered mobility with side information. In certain embodiments, one or more of the gNBs 101-103 includes circuitry, programing, or a combination thereof, to support low layer triggered mobility with side information in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

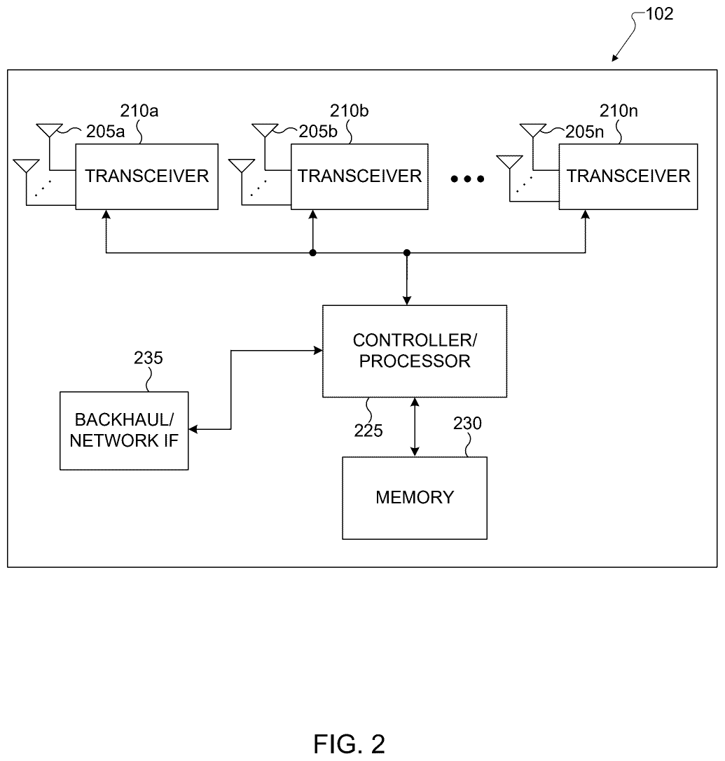

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to support low layer triggered mobility with side information as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

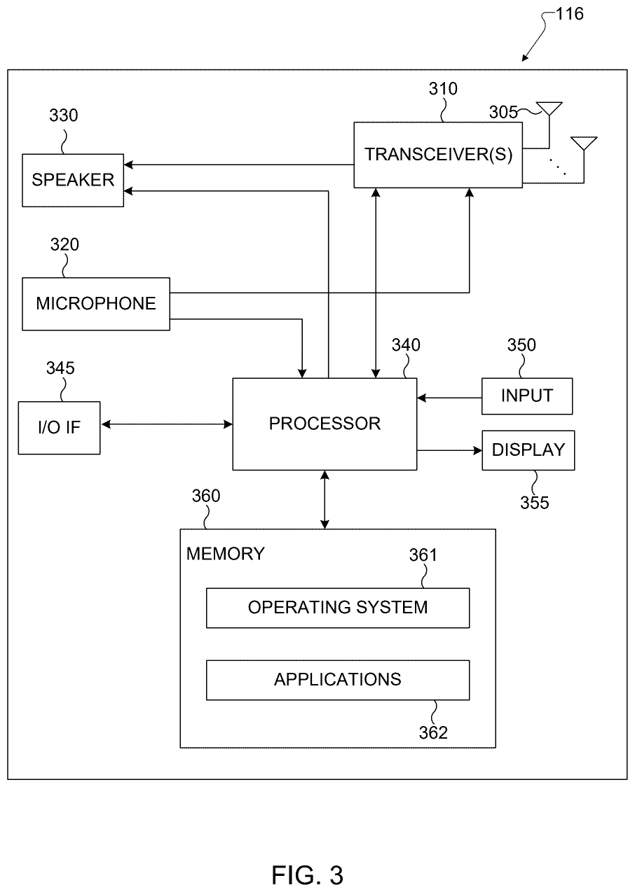

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for low layer triggered mobility with side information as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

Cellular communication is achieved by means of a network of nodes called gNBs. Mobility procedures are the procedures that enable cellular operation as the mobile device-or user equipment (UE)-moves from the coverage region of one gNB to another. Thus, the mobility procedures should ensure that handover (HO) between two gNBs does not cause service disruption to the UE.

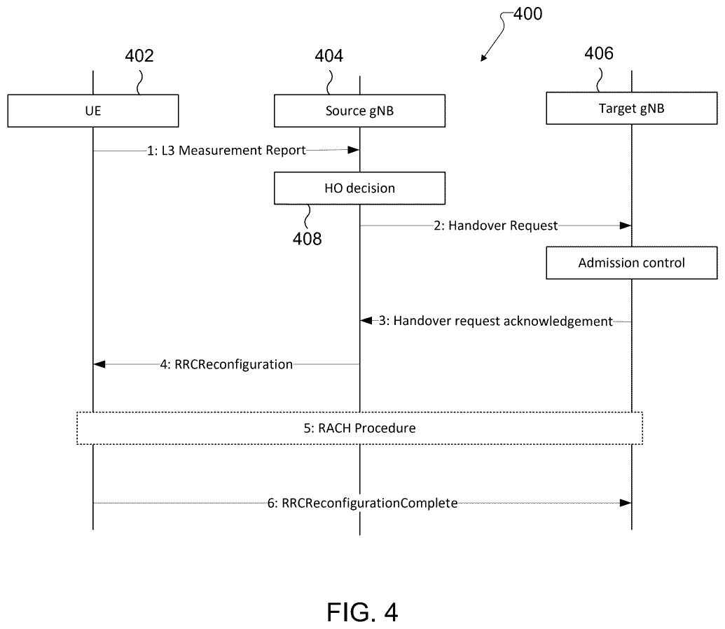

Release 15 of the 3rd generation partnership project (3GPP) specifications, which was the first release of 5G new radio (NR), provided mechanisms for the HO between gNBs. The baseline HO procedure is shown in FIG. 4.

FIG. 4 illustrates an example procedure 400 for baseline handover according to embodiments of the present disclosure. An embodiment of the procedure illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments for baseline handover could be used without departing from the scope of this disclosure.

In the example of FIG. 4, a UE 402 performs measurements and shares an L3 measurement report with source gNB 404 (Step 1). The L3 report means that there is a filter at layer 3 of the NR protocol stack, i.e., radio resource control (RRC), that is applied to the measurements and the filtered measurements are shared with gNB 404. The L3 filter is an infinite impulse response (IIR) filter, and the parameters of the filter are shared by the network (NW) with UE 402. Applying L3 filtering ensures that the measurements from different gNBs are filtered enough so that short term fluctuation is averaged out and does not impact the mobility procedure. Source gNB 404 takes the HO decision (block 408). Source gNB 404 then sends a HO request to target gNB 406 (Step 2). Target gNB 406 sends a HO request acknowledgement to the source gNB (Step 3). Source gNB 404 sends a RRCreconfiguration message to UE 402 (Step 4). The RRCreconfiguration message contains the configurations required for UE 402 to communicate with target gNB 406. UE 402 applies the target configurations and then attempts a random-access channel (RACH) procedure with target gNB 406 (Step 5). The RACH procedure is a synchronization procedure, and after completing the RACH procedure, UE 402 has uplink (UL) and downlink (DL) synchronization with target gNB 406. After successfully completing random access, UE 402 sends a RRCReconfigurationComplete message to target gNB 406 (Step 6).

Although FIG. 4 illustrates one example of a procedure 400 for baseline handover, various changes may be made to FIG. 4. For example, while shown as a series of steps, various steps in FIG. 4 could overlap, occur in parallel, occur in a different order, occur any number of times, be omitted, or replaced by other steps.

The baseline HO procedure of FIG. 4 is a break-before-make procedure. That is, the communication with source gNB 404 breaks before communication is established with target gNB 406. This procedure has a few limitations. First, the L3 measurement report is sent to source gNB 044, typically, when the link to source gNB 404 is already weak. As source gNB 404 makes the HO decision, sends the HO request, and receives acknowledgement, the link could further deteriorate. Due to the poor link, when gNB 404 sends the RRCreconfiguration message, it may not be correctly received at UE 402, which can lead to link failure. Second, the time after UE 402 receives the RRCreconfiguration message from source gNB 404 and before UE 402 sends the RRCreconfigurationcomplete message to target gNB 406 is in a period in which there may not be a data plane and no data can be exchanged between UE 402 and the NW. This period can be long enough to impact the user quality of experience (QoE), particularly in real-time applications like video call or extended reality (XR) applications. Subsequent releases from 3GPP have tried to address multiple issues with the baseline HO discussed above.

One mechanism proposed in 3GPP is conditional handover (CHO). In CHO, the source gNB sends the RRCreconfiguration message and the UE sends the back RRCreconfigurationcomplete message to the source gNB. The UE then on its own evaluates the CHO conditions, and if those conditions are met, it detaches from the source gNB and attaches to the target gNB. The benefit of CHO is that the RRCreconfiguration message is potentially sent in better channel conditions and as such the probability of failure in receiving the RRCreconfiguration message is lower than the baseline HO case.

Another mechanism is dual active protocol stack (DAPS). In DAPS, the UE maintains a protocol stack with both the source gNB and the target gNB. Specifically, after receiving the RRCreconfiguration message from the source gNB, the UE continues the UL/DL data transfer to/from the source gNB. In parallel, the UE initiates the RACH procedure to the target cell. After completing the RACH procedure to the target cell, the UE switches to the target cell, and sends the RRCreconfigurationcomplete message to the target cell. Thus, DAPS reduces the data interruption time of the baseline HO.

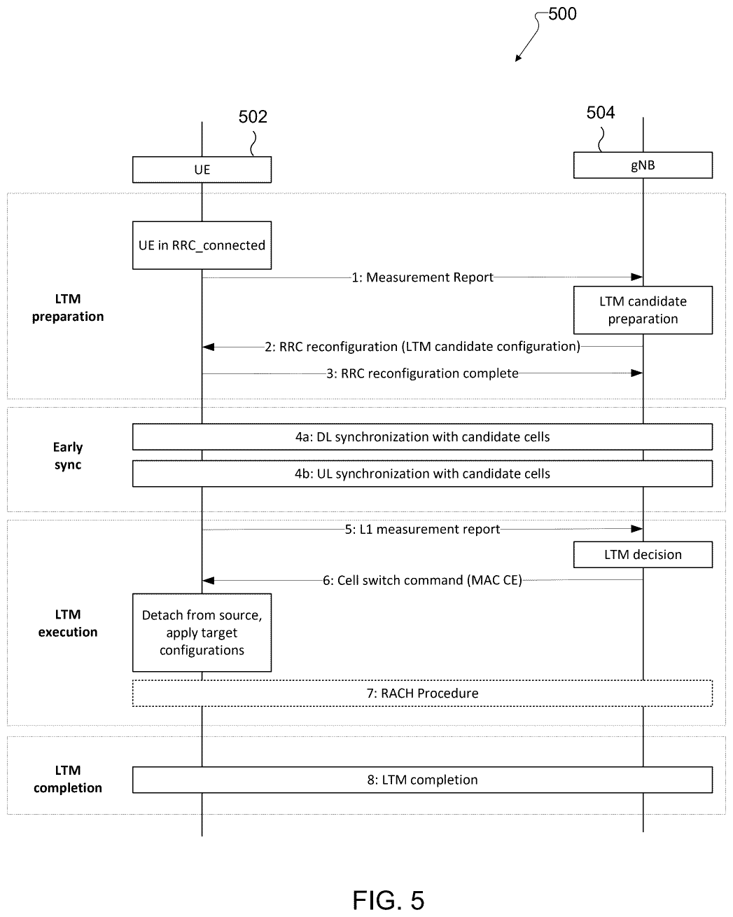

Another mechanism is low layer triggered mobility (LTM) that is introduced as part of the 3GPP Release 18. Note that, the baseline HO procedure is an L3 procedure. Specifically, the measurements used for the HO are L3 measurements. L3 measurements vary slowly and are not meant for rapid switching between gNBs. Further, the control signaling for the HO execution also happens at L3, e.g., the control messages sent by the gNB—i.e., RRCreconfiguration—and by the UE—i.e., RRCreconfigurationcomplete—are L3 messages that have a high overhead. In low layer triggered mobility, the HO decisions are based on L1 (or L2) measurements and the control signaling for HO execution is also based on L2 messages. This means that the LTM based mobility is much more dynamic than the baseline HO. The LTM procedure is shown in FIG. 5. In LTM, the source gNB will share the configurations of all the candidate cells with the UE. Based on the configurations that the UE receives, the UE can acquire early-sync with all the candidate cells. Then, during the LTM HO execution, the UE only shares the L1 filtered measurement reports with the gNB. The gNB may or may not apply the L2 filtering on the L1 measurements while making the HO decision. As such the HO decision is based on the L1 (or L2) measurements. Since the UE already has the configurations of all the candidate cells, the gNB does not need to communicate those configurations with the UE at this stage. It only sends the cell switch command, which is an L2 command, to the UE to change the gNB. The UE—which is potentially already synced with the target cell—simply switches to the target cell. Due to early-sync and L1 based nature of the LTM, rapid switching can be achieved between multiple gNBs. Though LTM procedure can be applied at any frequency, it is particularly suitable for high frequency, i.e., frequency range 2 or FR2, since FR2 operation is beam based and the beam quality across gNBs can vary rapidly. Further, there are hardware limitations in realizing FR2 systems and spatial beamforming/precoding may not be fully digital. With at least part of the precoding/beamforming being achieved in the analog front end, the UE needs to take break from data transmission/reception for monitoring the reference signals of the candidate target cells. Using LTM procedure, the UE can exploit the best beam from any gNB more dynamically for its data transmission/reception.

FIG. 5 illustrates an example procedure 500 for LTM handover according to embodiments of the present disclosure. An embodiment of the procedure illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments for LTM handover could be used without departing from the scope of this disclosure.

In the example of FIG. 5, a UE 502 performs measurements and shares an L3 measurement report with source gNB 504 similar as described regarding Step 1 of FIG. 5. Source gNB 504 sends a RRCreconfiguration message to UE 502 (Step 2). The RRCreconfiguration message contains the configurations required for UE 502 to communicate with at least one target gNB. UE 502 sends a RRCReconfigurationComplete message to target gNB 406 (Step 3). UE 502 applies the target configurations and then performs downlink (DL) synchronization (Step 4a) and uplink (UL) synchronization (Step 4b) with the candidate cells. UE 502 performs measurements and shares a L1 (or L2) measurement report with source gNB 504 (Step 5). gNB 504 sends a cell switch command to UE 502 (Step 6). UE 502 attempts a random-access channel (RACH) procedure with target a candidate cell (Step 7). The RACH procedure is a synchronization procedure, and after completing the RACH procedure, After successfully completing random access, UE 502 sends a LTM completion message to gNB 504 (Step 8).

Although FIG. 5 illustrates one example of a procedure 500 for LTM handover, various changes may be made to FIG. 5. For example, while shown as a series of steps, various steps in FIG. 5 could overlap, occur in parallel, occur in a different order, occur any number of times, be omitted, or replaced by other steps.

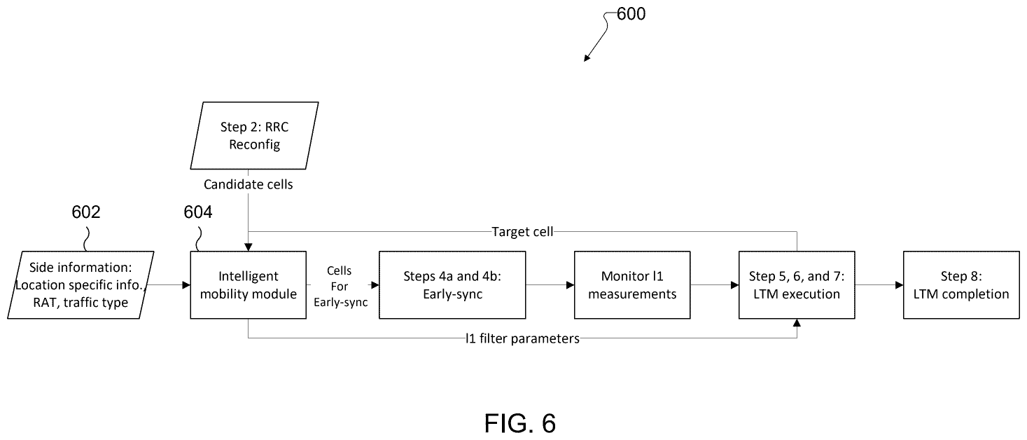

The main problem with low layer triggered mobility (LTM) of the Release 18 of 3GPP is the complexity at the UE. Specifically, the UE needs to do early-sync with all the candidate cells (note that, in this disclosure, we use the term gNB and cells interchangeably). This places a substantial computational and processing burden on the UE. The UE needs to decode and apply RRC configurations of all the candidate cells. The UE then monitors the reference signals of multiple gNBs and then processes and—possibly—decodes those to acquire and maintain synchronization with the candidate gNBs. To overcome these issues, the present disclosure provides a procedure for LTM HO utilizing side information. The overall procedure of LTM with side information is shown in FIG. 6.

FIG. 6 illustrates an example procedure 600 for LTM handover with side information according to embodiments of the present disclosure. An embodiment of the procedure illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments for LTM handover with side information could be used without departing from the scope of this disclosure.

In the example of FIG. 6, the steps that are consistent with the LTM procedure-as considered by 3GPP-are referenced by their respective step numbers from FIG. 5. At block 604, the UE (which includes an intelligent mobility module) obtains side information 602 (e.g., location specific information). The location specific information could contain the candidate cells that were previously configured for the location, and also which of those cells actually became target cells. The UE could obtain the location e.g., from the GPS module or with the help of cellular communication. The location specific information, e.g., information about past candidate cells, is maintained at the UE from its own observations. In other implementations, this information could be collaboratively obtained from other mobile devices. In addition to the location-based information, the UE could obtain other pieces of information, e.g., the current traffic type, e.g., whether the current traffic is real-time (RT) or non-real-time (NRT), and the radio access technology (RAT) information, i.e., whether the RAT is standalone (SA) or non-standalone (NSA). The information about the current traffic type could be based, for example, on the quality of service (QOS) maintenance framework of the 5G, i.e., based on the 5G QOS Identifier (5QI). As part of the communication protocol, the UE is aware of the 5QI of the currently active traffic. The traffic type information could also be based on a proprietary service type detector module that may be implemented on the UE specifically to detect the traffic type. The RAT information is also available to the device as part of the cellular operation. When the UE receives the RRC reconfiguration message from the NW, it is aware of all the current candidate cells. Then the UE uses the side information e.g., location based, traffic type, and RAT, to make an intelligent decision about which candidate cells to early-sync to. This helps the UE avoid all the unnecessary computational burden that comes with early-sync to candidate cells that are less likely to become the target cells. Subsequently, the UE does early-sync (Steps 4A and 4b) to the determined cells and the LTM HO is executed (Steps 5, 6, and 7). After LTM execution, the UE knows which cells actually became the target cells. The feedback about actual target cells is then provided to the intelligent mobility module to improve its performance for future. The final step is the LTM completion (Step 8). Subsequent embodiments provide the detailed implementation and variations of the intelligent mobility module based on different pieces of side information.

Although FIG. 6 illustrates one example of a procedure 600 for LTM handover with side information, various changes may be made to FIG. 6. For example, while shown as a series of steps, various steps in FIG. 6 could overlap, occur in parallel, occur in a different order, occur any number of times, be omitted, or replaced by other steps.

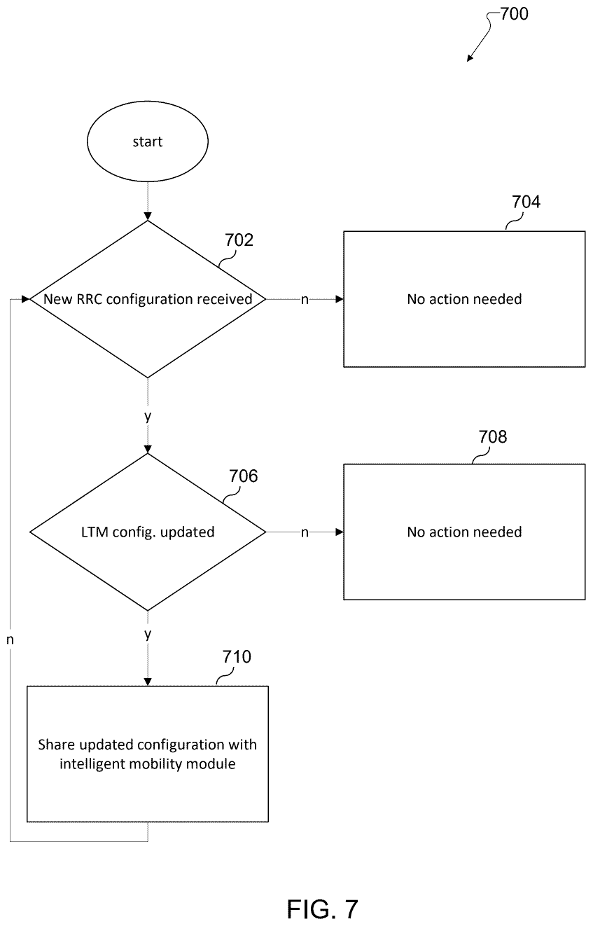

For the overall procedure, the intelligent mobility module of the UE should update every time an RRC reconfiguration related to LTM is received as shown in FIG. 7.

FIG. 7 illustrates an example procedure 700 for updating a configuration in an intelligent mobility module according to embodiments of the present disclosure. An embodiment of the procedure illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments for updating a configuration in an intelligent mobility module could be used without departing from the scope of this disclosure.

In the example of FIG. 7, the procedure begins at block 702. At block 702, the UE continuously checks if an RRC reconfiguration message is received or not (e.g., from Step 2 of FIG. 6). If there is no RRC reconfiguration message received, there is no action required (block 704). If, however, there is an RRC reconfiguration received, then at block 706 the UE checks if the configuration message contains some configuration related to LTM. If not, then there is no action required (block 708). Finally, if there is some configuration related to LTM, then at block 710 this configuration is shared with the intelligent mobility module.

Although FIG. 7 illustrates one example of a procedure 700 for updating a configuration in an intelligent mobility module, various changes may be made to FIG. 7. For example, while shown as a series of steps, various steps in FIG. 7 could overlap, occur in parallel, occur in a different order, occur any number of times, be omitted, or replaced by other steps.

In some embodiment, the side information could be updated in the intelligent connectivity module whenever there is updated side information, e.g., location information from the GPS may be shared every 1 sec, update traffic type may be shared every 0.5 seconds, and RAT whenever RAT changes.

In some embodiments, the early sync should be performed to a new cell whenever there is a new cell for early-sync determined by the intelligent mobility module, which could happen either when the LTM configuration changes or the side information changes. Early sync should also be performed whenever it is determined that the sync may be lost to a cell to which the device achieved synchronization in the past. This determination could be based on timing thresholds (e.g., more than 2 seconds have passed) since last time the device synced. The monitoring of L1 measurement is a continuous process-the measurement interval could be several milliseconds, e.g., 40 ms.

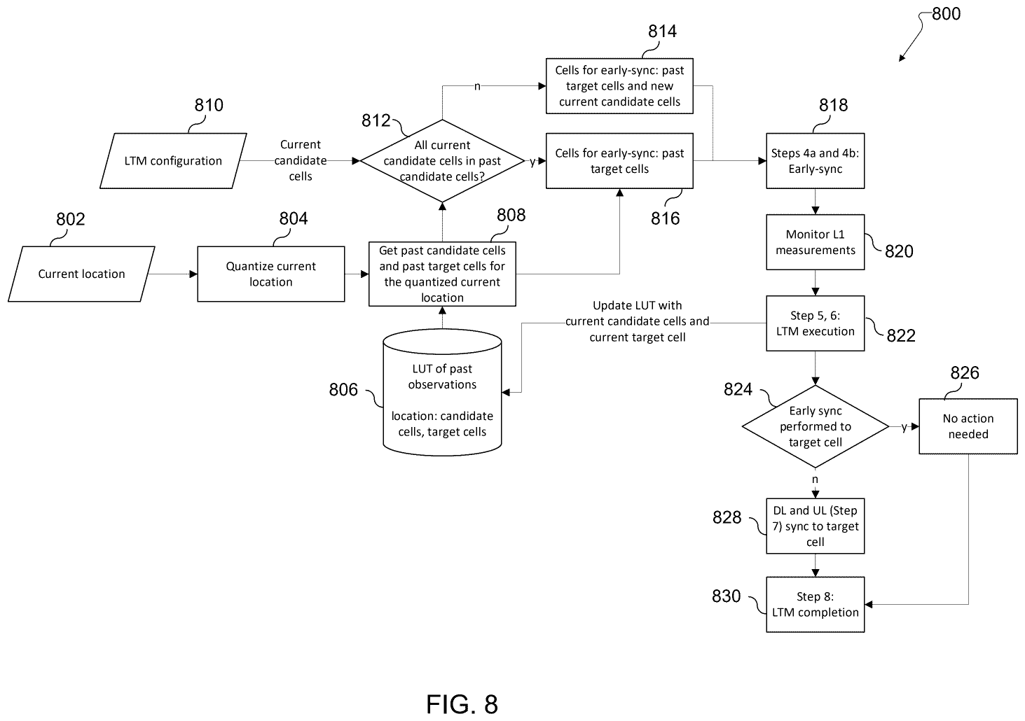

In one embodiment, the location-based information is used to down select the candidate cells for early-sync as shown in FIG. 8.

FIG. 8 illustrates an example procedure 800 for location based candidate cell early-sync selection according to embodiments of the present disclosure. An embodiment of the procedure illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments for location based candidate cell early-sync selection could be used without departing from the scope of this disclosure.

In the example of FIG. 8, the current location 802 is used as an input. The location information could come solely from GPS or aided by other methods to localize, e.g., based on cellular communications or by aid of sensors on the device, e.g., an inertial measurement unit (IMU). The location is subsequently quantized at block 804.

The relevance of the quantization operation is as follows: the location based solution is based on a look up table (LUT) of past observations 806. These observations are stored with a pre-determined granularity, e.g., one data-point for every 50 m. This way measurements within a predefined stretch on a road, or a geographical area, are gathered into a single location data-point. All observations within the defined area are thus captured together. The granularity is a system parameter but provides the following trade off: the higher the granularity, the bigger the LUT. This implies more storage cost and also the cost of looking up the table during online operation increases. With a lower granularity, the LUT becomes smaller and the cost to look up the table decreases, but there could be substantial variations in the signal quality from different gNBs for the bigger geographical area. As such, a larger number of candidate gNBs may be seen becoming target gNBs as the granularity is decreased—hence potentially reducing the gain of the method. Another option is to have adaptive granularity, in which close to cell edges the granularity is increased whereas in cell center granularity is decreased to achieve a good tradeoff in performance and storage/look up complexity. This is feasible since more inter-gNB HOs are likely in cell edge scenarios compared to cell center scenario.

The location quantization operation maps the current location input to one of the location data-points in the LUT. Subsequently, at block 808 the candidate cells and the target cells from the past are obtained based on the LUT of the past observations 806 at the location. The RRC configuration step (Step 2) from the LTM procedure of FIG. 5 provides the current candidate cells (block 810). At block 812 a check is performed to see if there is any cell in the current candidate cells that has not been a candidate cell in the past. This scenario can arise in two cases, (i) when the past measurements at the location are few (e.g., 1 to 2) and as such do not fully capture the candidate cells available at that location, and (ii) due to changes in the NW, e.g., installation of a new site to improve coverage. If there is a current candidate cell that was not one of the candidate cells in the past, then this cell is considered one of the cells to which the device will perform early-sync (block 814). In addition, all the current candidate cells that were target cells in the past will also be considered cells to which the device will perform early-sync (blocks 814 and 816). In another embodiment, the direction is also considered while determining the past candidate and target cells. One possibility is to consider the current quantized location, conditioned on the past quantized location. For example, let the quantized locations be indexed as lᵢ, where i is the location index. In this case, if the user arrives at lₖ from a location lₘ, the set of past candidate and target cells can be different than the case when the user arrives at location lₖ from a location lₙ. One can think of location lₖ as one location on a two way road. Then lₘ is the last location before location lₖ if the user travels on one side of the road, and lₙ is the last location before location lₖ if the user travels on the other side of the road. The UE does not perform early-sync to other cells, as those cells are less likely to be target cells and not doing early-sync to those cells can help UE save on computations. Based on the result of block 812, the UE performs steps 4a and 4b (block 818) with the cells identified for early-sync. At block 820, the UE monitors L1 measurements.

At block 822, note that steps 5 and 6 of the LTM procedure are referred to as LTM execution, even though strictly speaking step 7, i.e., RACH—if performed—is also part of the LTM execution phase in FIG. 5. If step 7 is performed, it is considered a separate step as in FIG. 6. After LTM execution, i.e., step 5 and 6, LUT 806 can be updated with the information of the candidate cells and target cells to keep LUT 806 continuously updated. Also, after LTM execution, if it is determined that the target cell is one of the cells to which the UE has performed early sync (block 824), there is no action needed (block 826) and the LTM process can complete (block 830). If, however, the target cell is one of the cells to which the UE has not performed early-sync then the UE performs sync to the target cell (block 828) and completes the LTM procedure (block 830).

Although FIG. 8 illustrates one example of a procedure 800 for location based candidate cell early-sync selection, various changes may be made to FIG. 8. For example, while shown as a series of steps, various steps in FIG. 8 could overlap, occur in parallel, occur in a different order, occur any number of times, be omitted, or replaced by other steps.

Note that in addition to random access based timing advance (TA) acquisition, one possibility is to allow the UE to do the TA estimation. The approach considered for UE estimation is for the UE to know the TA of the serving cell, and then receive reference signals (RS) s from the serving cell and candidate cells. The UE then compares the timing of the reference signals from candidate cells to get the timing advance. For the location and LUT based intelligent mobility as in FIG. 8, the LUT can also include the TA information of the cells that became target cells in the past. This information is then used to perform the UL early synchronization. In one embodiment, the TA of the cell stored in the LUT at the current quantized location is used as is for the UL sync. In another embodiment, the TA is obtained by interpolating over the quantized locations and comparing with unquantized UE locations.

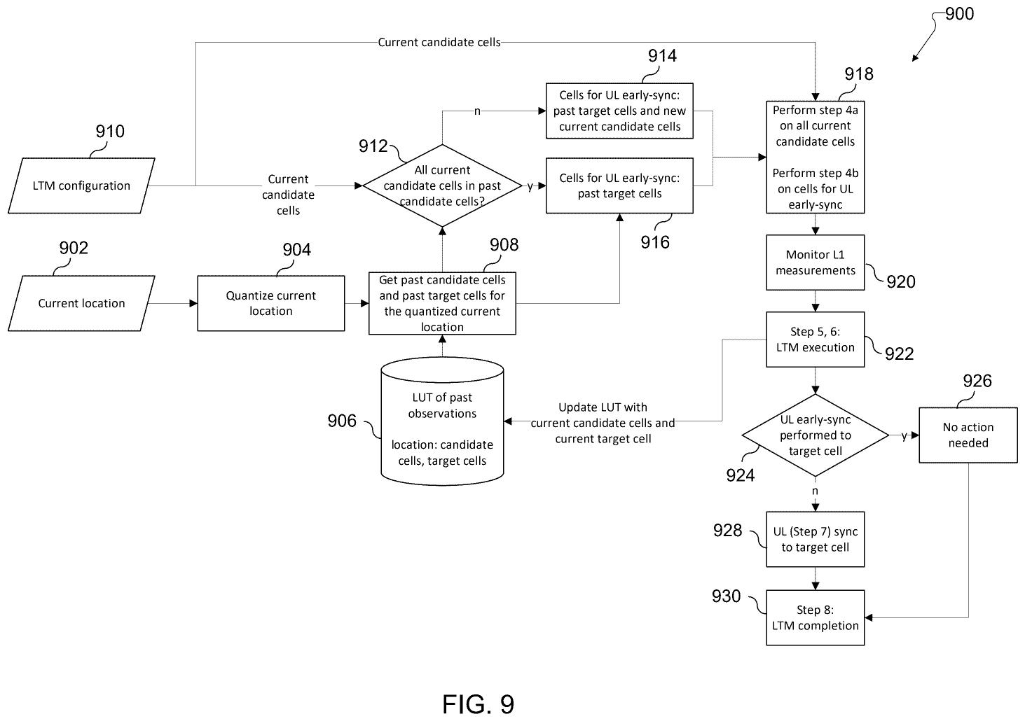

In one embodiment, DL early-sync is performed to all candidate cells, whereas UL early-sync is performed only to past target cells, plus new candidate cells—if any—as shown in FIG. 9. The rationale for the design is as follows: performing DL sync is easier than performing UL sync. For DL sync, the UE monitors the synchronization signal blocks (SSBs) that are broadcasted by the gNB. In contrast UL sync requires a RACH procedure. First, the UE needs to wait for the RACH resources, then perform random access, and obtain a random access response (RAR) including timing advance (TA). In this embodiment, after performing the location quantization, looking up the LUT, and checking whether all the current candidate cells were candidate cells in the past or not, the UE determines the cells for UL early-sync. The step 4a, i.e., DL early-sync is performed with all the candidate cells, whereas step 4b, i.e., UL early-sync is performed only with the cells determined for UL early-sync. After LTM execution, the LUT is updated. If the target cell is one of the cells on which UL early-sync is already performed no action is required and the LTM procedure completes. Whereas, if the target cell is one of the cells for which UL early-sync is not performed, step 7, i.e., RACH, is executed for UL sync to the target cell and the LTM procedure completes.

FIG. 9 illustrates another example procedure 900 for location based candidate cell early-sync selection according to embodiments of the present disclosure. An embodiment of the procedure illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments for location based candidate cell early-sync selection could be used without departing from the scope of this disclosure.

In the example of FIG. 9, the current location 902 is used as an input. The location information could come solely from GPS or aided by other methods to localize, e.g., based on cellular communications or by aid of sensors on the device, e.g., an inertial measurement unit (IMU). The location is subsequently quantized at block 904.

The location quantization operation maps the current location input to one of the location data-points in the LUT. Subsequently, at block 908 the candidate cells and the target cells from the past are obtained based on the LUT of the past observations 906 at the location. The RRC configuration step (Step 2) from the LTM procedure of FIG. 5 provides the current candidate cells (block 910). At block 912 a check is performed to see if there is any cell in the current candidate cells that has not been a candidate cell in the past. If there is a current candidate cell that was not one of the candidate cells in the past, then this cell is considered one of the cells to which the device will perform UL early-sync (block 914). In addition, all the current candidate cells that were target cells in the past will also be considered cells to which the device will perform UL early-sync (blocks 914 and 916). In another embodiment, the direction is also considered while determining the past candidate and target cells. Based on the result of block 912, at block 918 the UE performs DL early-sync with all the candidate cells (step 4a) and the UE performs UL early-sync only with the cells determined for UL early-sync (step 4b) with the cells identified for early-sync. At block 920, the UE monitors L1 measurements.

At block 922, note that steps 5 and 6 of the LTM procedure are referred to as LTM execution, even though strictly speaking step 7, i.e., RACH—if performed—is also part of the LTM execution phase in FIG. 5. If step 7 is performed, it is considered a separate step as in FIG. 6. After LTM execution, i.e., step 5 and 6, LUT 906 can be updated with the information of the candidate cells and target cells to keep LUT 906 continuously updated. Also, after LTM execution, if it is determined that the target cell is one of the cells to which the UE has performed early sync (block 924), there is no action needed (block 926) and the LTM process can complete (block 930). If, however, the target cell is one of the cells to which the UE has not performed early-sync then the UE performs sync to the target cell (block 928) and completes the LTM procedure (block 930).

Although FIG. 9 illustrates one example of a procedure 900 for location based candidate cell early-sync selection, various changes may be made to FIG. 9. For example, while shown as a series of steps, various steps in FIG. 9 could overlap, occur in parallel, occur in a different order, occur any number of times, be omitted, or replaced by other steps.

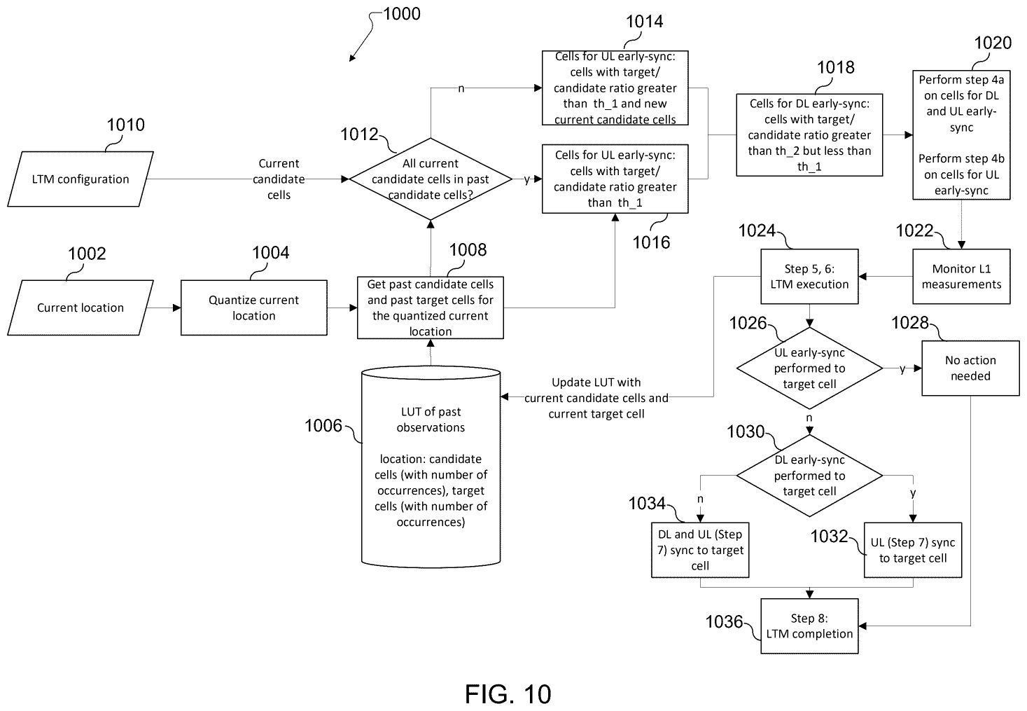

In another embodiment, candidate cells are ranked according to their probability of being a target cell as shown in FIG. 10.

FIG. 10 illustrates another example procedure 1000 for location based candidate cell early-sync selection according to embodiments of the present disclosure. An embodiment of the procedure illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments for location based candidate cell early-sync selection could be used without departing from the scope of this disclosure.

In the example of FIG. 10, the UE obtains the location 1002, quantizes it (block 1004), and then looks up (block 1008) the table 1006. Table 1006 not only include the candidate and target cell information from the past, but also the number of occurrences. The number of candidate and target cell occurrences allow the device to calculate the probability of a cell being high, medium or low probability to become a target cell by calculating the probability of a cell becoming the candidate cell and comparing it with thresholds. Specifically, the probability of a cell becoming target cell is the ratio of the number of observations at a location and the number of times the cell became a target cell in that location. The RRC configuration step (Step 2) from the LTM procedure of FIG. 5 provides the current candidate cells (block 1010). At block 1012 a check is performed to see if there is any cell in the current candidate cells that has not been a candidate cell in the past. If the probability of a candidate cell is higher than a threshold th_1 (blocks 1014 and 1016) or the cell is a new current candidate cell (block 1014), then the cell has a high chance of becoming a target cell and both DL and UL early-sync are performed to this cell block 1020). If the probability is less than th_1, but higher than th_2 (block 1018), then the cell has a medium likelihood of becoming a target cell. In this case, only DL sync is performed to the cell. (block 1020). Finally, if the probability is less than th_2, then the cell has a low probability of becoming a candidate cell and neither the DL, nor the UL synchronization is maintained for the cell. Example values of th_1 and th_2 are 0.5 and 0.1. At block 1022, the UE monitors L1 measurements.

At block 1024, note that steps 5 and 6 of the LTM procedure are referred to as LTM execution, even though strictly speaking step 7, i.e., RACH—if performed—is also part of the LTM execution phase in FIG. 5. If step 7 is performed, it is considered a separate step as in FIG. 6. After the LTM execution, LUT table 1006 is updated. At block 1026, if UL pre-sync has been performed to the target cell no action is required (block 1028) and the LTM procedure can complete (block 1036). If, however, only DL pre-sync is performed, at block 1032 then UL sync is performed to the candidate cell and the LTM completes (block 1036). Finally, if neither DL nor UL early-sync is performed to the target cell, then at block 1034 both the UL and DL sync is performed to the target cell and the LTM procedure completes (block 1036).

In another embodiment, the order of the candidate cells to pre-sync is also determined based on the probability. Specifically, the device performs early-sync to the highest probability candidate cell first, then to the second highest probability candidate cell, and so on.

In yet another embodiment, new cells—e.g., cells that were not seen before—are considered at least a few times before they are ignored for not becoming target cells.

Although FIG. 10 illustrates one example of a procedure 1000 for location based candidate cell early-sync selection, various changes may be made to FIG. 10. For example, while shown as a series of steps, various steps in FIG. 10 could overlap, occur in parallel, occur in a different order, occur any number of times, be omitted, or replaced by other steps.

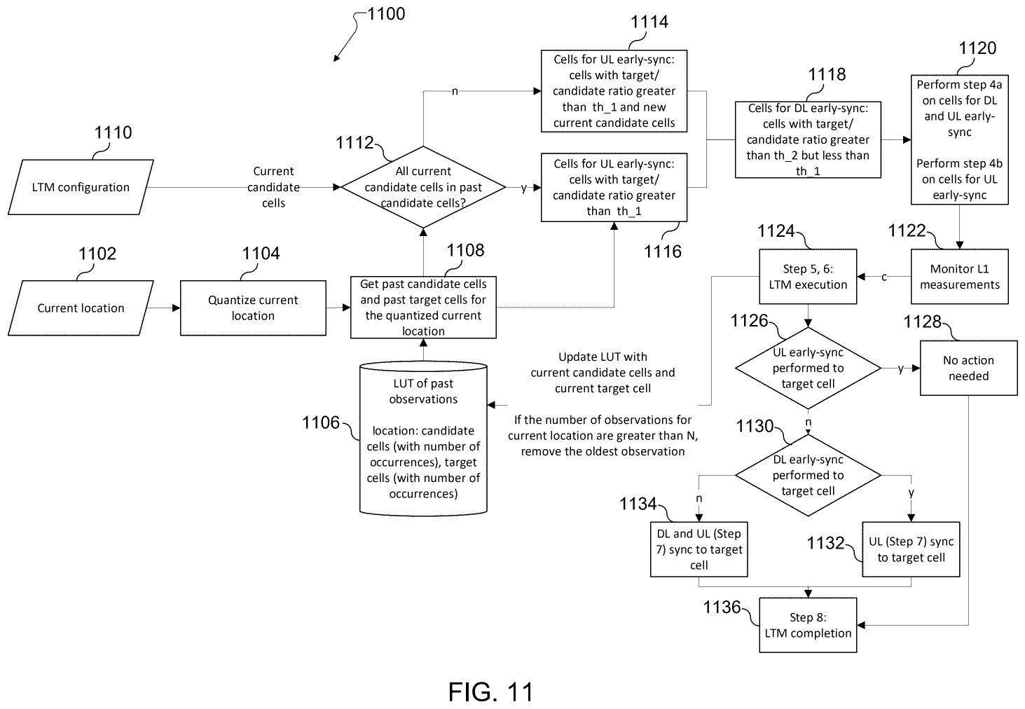

Since the NW and environment keeps changing while in operation, there is value in retaining only the freshest observations in the LUT. As an example, construction of a building, could mean that a cell that in the past became a target cell often no longer becomes a target cell. Also, there could be NW updates, e.g., removal of a site and installation of a new site at a slightly different location, tilting of an antenna panel or replacement of an antenna panel with a different panel having a different antenna pattern. Depending on the number of observations at a location in the past, the new scenario may take several observations before it can impact the decision of early-sync. Specifically, in the probability based solution, in which the fraction of the times a cell becomes a target cell is used to determine whether the cell is high probability to become target cell, if a large number of observations for a cell in an old scenario (before NW or environment change) exists, then a large number of measurements would be needed for the new scenario (after NW or environment change) also for accurate probability calculation in the new scenario. This is because the probability is calculated based on the total observations at a given location. To circumvent this, a solution is provided as shown, by way of example, in FIG. 11. The solution is similar to probability-based solution of FIG. 10, except in the update of the LUT. Specifically, only up to N most recent observations are retained for a location. This can be realized in various ways, e.g., by keeping a time-stamp corresponding to each measurement and on getting the latest observation, if there are already N observations for the location, the observation with the oldest time stamp is removed. Alternatively, a first in first out (FIFO) buffer of length N can be maintained for each location data-point. An example value of N could be 10. Instead of keeping N most recent observations, another possibility is to keep observations from a certain period T, e.g., 1 month period. In this case, most recent N measurements from within a month are kept. Specifically, if there more than N measurements from the period T, then recent most N observations are kept, otherwise all available observations from the period T are kept.

FIG. 11 illustrates another example procedure 1100 for location based candidate cell early-sync selection according to embodiments of the present disclosure. An embodiment of the procedure illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments for location based candidate cell early-sync selection could be used without departing from the scope of this disclosure.

In the example of FIG. 11, the UE obtains the location 1102, quantizes it (block 1104), and then looks up (block 1108) the table 1106. Table 1106 not only include the candidate and target cell information from the past, but also the number of occurrences. The number of candidate and target cell occurrences allow the device to calculate the probability of a cell being high, medium or low probability to become a target cell by calculating the probability of a cell becoming the candidate cell and comparing it with thresholds. Specifically, the probability of a cell becoming target cell is the ratio of the number of observations at a location and the number of times the cell became a target cell in that location. The RRC configuration step (Step 2) from the LTM procedure of FIG. 5 provides the current candidate cells (block 1110). At block 1112 a check is performed to see if there is any cell in the current candidate cells that has not been a candidate cell in the past. If the probability of a candidate cell is higher than a threshold th_1 (blocks 1114 and 1116) or the cell is a new current candidate cell (block 1114), then the cell has a high chance of becoming a target cell and both DL and UL early-sync are performed to this cell block 1120). If the probability is less than th_1, but higher than th_2 (block 1118), then the cell has a medium likelihood of becoming a target cell. In this case, only DL sync is performed to the cell. (block 1120). Finally, if the probability is less than th_2, then the cell has a low probability of becoming a candidate cell and neither the DL, nor the UL synchronization is maintained for the cell. Example values of th_1 and th_2 are 0.5 and 0.1. At block 1122, the UE monitors L1 measurements.

At block 1124, note that steps 5 and 6 of the LTM procedure are referred to as LTM execution, even though strictly speaking step 7, i.e., RACH-if performed-is also part of the LTM execution phase in FIG. 5. If step 7 is performed, it is considered a separate step as in FIG. 6. After the LTM execution, LUT table 1106 is updated. At block 1126, if UL pre-sync has been performed to the target cell no action is required (block 1128) and the LTM procedure can complete (block 1136). If, however, only DL pre-sync is performed, at block 1132 then UL sync is performed to the candidate cell and the LTM completes (block 1136). Finally, if neither DL nor UL early-sync is performed to the target cell, then at block 1134 both the UL and DL sync is performed to the target cell and the LTM procedure completes (block 1136).

Although FIG. 11 illustrates one example of a procedure 1100 for location based candidate cell early-sync selection, various changes may be made to FIG. 11. For example, while shown as a series of steps, various steps in FIG. 11 could overlap, occur in parallel, occur in a different order, occur any number of times, be omitted, or replaced by other steps.

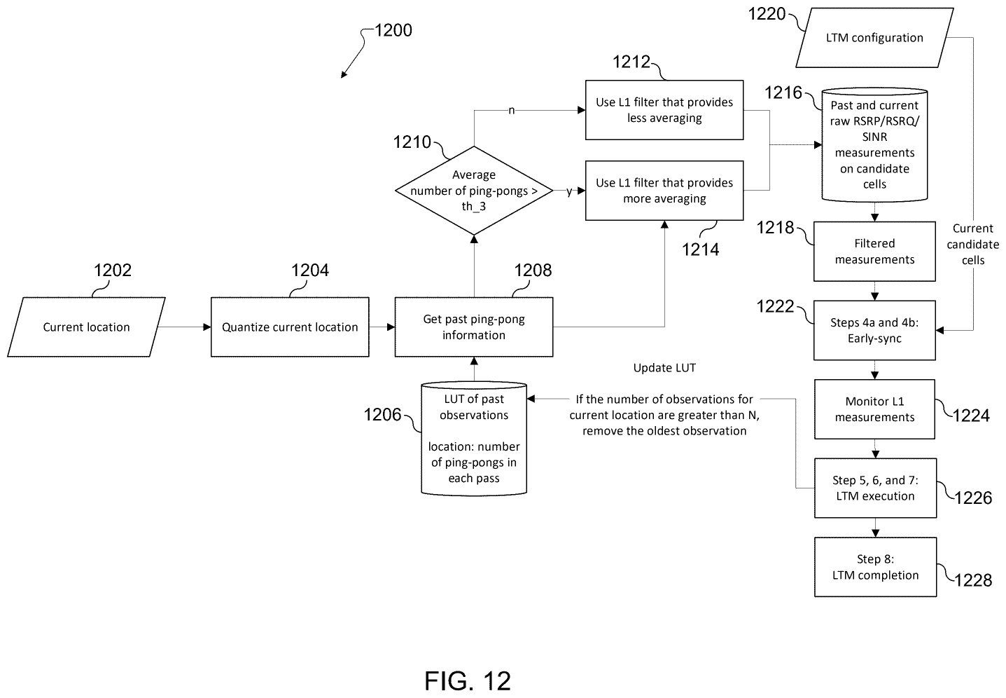

After doing the measurements of signal quality metrics, e.g., reference signal received power (RSRP), reference signal received quality (RSRQ), and signal to interference plus noise ratio (SINR), the UE performs L1 filtering on the measurements, and the L1 filtered measurements are shared with the NW for LTM HO procedure. The design of the L1 filter is left to the UE implementation. It is thus UE's discretion to choose the L1 filter length and coefficients. In one embodiment, the choice of the UE filter is location specific as shown in FIG. 12.

FIG. 12 illustrates an example procedure 1200 for location based layer 1 filtering according to embodiments of the present disclosure. An embodiment of the procedure illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments for location based layer 1 filtering could be used without departing from the scope of this disclosure.

In the example of FIG. 12, the L1 filter is used to minimize the ping-pong at the location. Note that the ability to rapidly switch between multiple gNBs is the hallmark of the LTM operation. That said, ping-pong, i.e., going back to the same gNB within 1 second is undesirable as ping-pong could indicate impact of short term variations and noise on the HO decision. As such in locations where ping-pongs are experienced in the past, the UE may decide to use an L1 filter that can result in more averaged measurements and hence the ping-pong due to measurement noise can be reduced. Specifically, at block 1204 the UE obtains the current location 1202 and performs the location quantization operation at block 1204. Subsequently at block 1208, the UE obtains the ping-pong information 1206 about the location, and at block 1210, if the average number of ping-pongs at the location are greater than ping-pong threshold th_3, then the UE uses an L1 filter that provides more measurement averaging—to minimize ping-pongs (block 1214). Similarly, if the number of ping-pongs at the location are less than ping-pong threshold th_3, then the UE uses an L1 filter that provides less averaging—to permit rapid switching (block 1212). The average number of ping-pongs is the average calculated across different observations at that given location. Note that, on top of the L1 filtering, the gNB may itself decide to apply L2 filtering before taking the LTM decision, but that is beyond the UE's control or knowledge. Also note that the length of the two L1 filters may be different. Since the UE may switch between the two filters, the UE may need to store a certain number of past measurements, in case the L1 filter needs to be switched. Specifically, if the order of the larger of the two filters is L, then the UE needs to store L past measurements (block 1216). Remaining steps of the LTM execution are the same as in FIG. 5.

At block 1218, the UE monitors filtered L1 measurements. At block 1222, the UE performs steps 4a and 4b based on the filtered measurements 1218 and LTM configuration 1220. At block 1224 the UE monitors L1 measurements. At block 1226, the UE performs LTM execution. The LUT is updated to keep track of the number of ping-pongs at the location. At step 1228, the UE performs LTM completion.

An example value of ping-pong threshold th_3 is 1. A simple filter design would be a moving average filter, where for a filter of order L, all filter coefficients are 1/(L+1). Example value of L for a filter providing less averaging is 1, and an example value of L for a filter providing more averaging is 3.

In another embodiment, the location information is used both for L1 filter design as in FIG. 12, and for determining the cells to do early sync as in FIG. 6, FIG. 8 FIG. 9, FIG. 10, or FIG. 11.

Although FIG. 12 illustrates one example of a procedure 1200 for location based layer 1 filtering, various changes may be made to FIG. 12. For example, while shown as a series of steps, various steps in FIG. 12 could overlap, occur in parallel, occur in a different order, occur any number of times, be omitted, or replaced by other steps.

In another embodiment, the UE bases the decision on whether to perform early sync with the candidate cells based on traffic type. In traffic type based decision on early-sync, the UE is aware of the current traffic type that is being consumed at the UE. This is determined via a traffic classification module at the device. The traffic classification module may consider both IP packet history and PHY layer metrics to determine the application(s) that are running on the device. Different applications can be broadly categorized into real time and non-real time traffic, e.g.,
Non-real time traffic: Streaming (e.g., YouTube, Netflix, Prime video, etc.), browsing (e.g., browsing in an app or on web browser).
Real time traffic: Audio call (e.g., WhatsApp, Messenger, Viber, etc.), video call (e.g., WhatsApp, Messenger, MS Teams, etc.), Online low-bit rate gaming (e.g., Among Us), Online high-bit rate gaming (e.g., PUBG, Call of duty, etc.).

The application classes can also be subclassified to have more than two classes. As an example, there can be four classes: (i) real time low throughout, (ii) real time high throughput, (iii) non-real time low throughput, and (iv) non-real time high throughput. The traffic classification module may take IP packet history over a specified time window as input and predicts the applications that may be running at the UE. The module may consider features such as packet inter-arrival time, packet size, flow type, number of active flows, traffic class of each flow, etc., to determine the application. Further, the 3GPP specified 5QI values associated with the packet data unit (PDU) session may also indicate the traffic class. The module could output the predicted traffic class, or the probabilities of each class. The traffic classifier may be implemented using machine learning (ML) algorithms like XGBoost or convolutional neural networks (CNN) etc. The traffic classifier can be implemented based on all the IP traffic, i.e., all packets, or based on the flows, i.e., separate classification for each five-tuple (source IP address/port number, destination IP address/port number and the protocol in use, i.e., transmission control protocol (TCP)/user datagram protocol (UDP) etc). The additional information along with inference from IP packet history may result in more accurate detection of the service type.

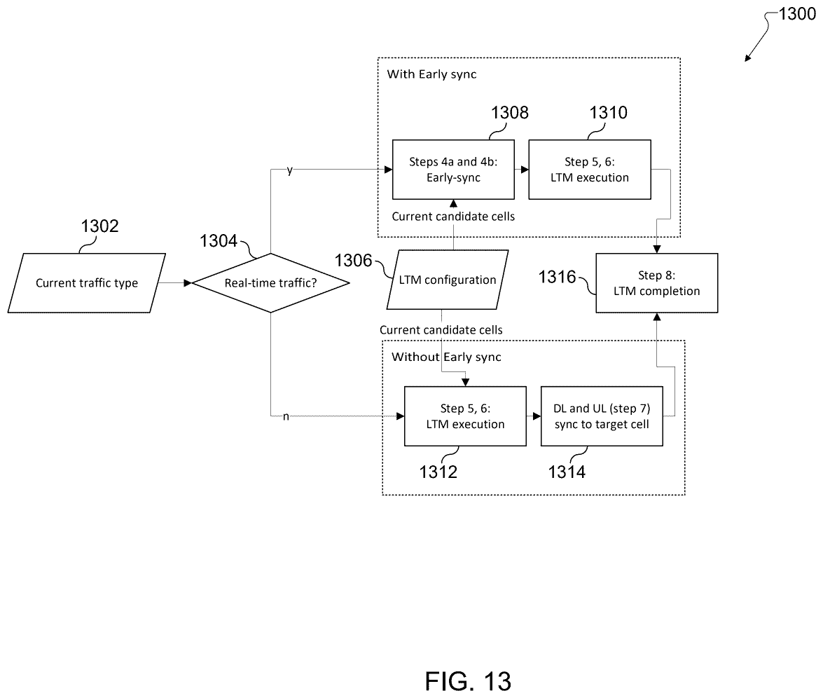

As discussed above, early-sync to multiple candidate cells is costly from UE processing point of view. If the UE is consuming only NRT traffic, then the UE does not need to early-sync since NRT traffic is not latency sensitive. In contrast if there is some RT traffic—also including the case when there is both RT and NRT traffic—then early-sync can be performed since the main benefit of early-sync is to reduce the HO interruption period, which negatively impacts the UE QoE—particularly for RT applications. An example embodiment of the method is given in FIG. 13.

FIG. 13 illustrates an example procedure 1300 for traffic based candidate cell early-sync selection according to embodiments of the present disclosure. An embodiment of the procedure illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments for traffic based candidate cell early-sync selection could be used without departing from the scope of this disclosure.

In the example of FIG. 13, at block 1304 the UE determines if the current traffic type 1302 is RT traffic. If current traffic type 1302 is RT traffic, at block 1308 the UE performs early sync with the current candidate cells according to LTM configuration 1306, performs LTM execution at block 1310, and performs LTM completion at block 1316. If the current traffic type 1302 is not RT traffic, at block 1312 the UE performs LTM execution with the current candidate cells according to LTM configuration 1306 without performing early sync, and at block 1314 the UE performs L and UL sync with the target cell. Finally, at block 1316 the UE performs LTM completion.

Although FIG. 13 illustrates one example of a procedure 1300 for traffic based candidate cell early-sync selection, various changes may be made to FIG. 13. For example, while shown as a series of steps, various steps in FIG. 13 could overlap, occur in parallel, occur in a different order, occur any number of times, be omitted, or replaced by other steps.

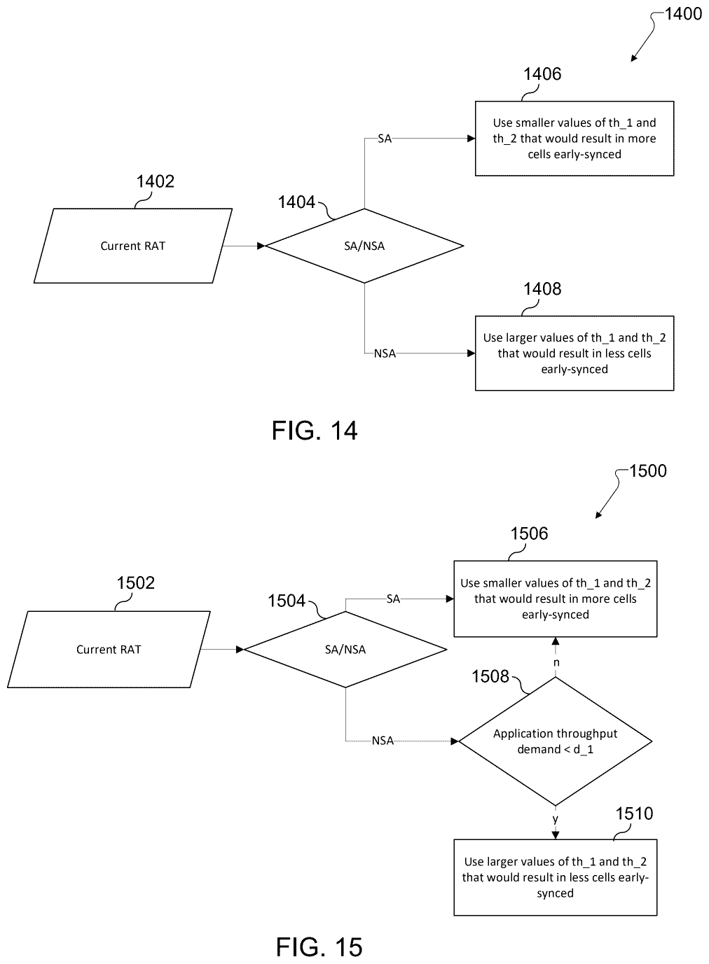

5G NR can be realized with several architectures which can be broadly categorized into standalone (SA) and non-standalone (NSA), henceforth called radio access technologies (RATs). Typically, NSA architecture relies on Evolved Universal Terrestrial Radio Access Network (EUTRAN), e.g., the control plane could be on EUTRAN, whereas the data plane is on NR. The predominant mode of NSA implementation is E-UTRAN New Radio-Dual Connectivity (ENDC) in which the UE is simultaneously connected to the air interface of both EUTRAN and NR. In ENDC, the data can simultaneously be transmitted/received through EUTRAN/NR air interfaces. As such, if NR connectivity is not available—e.g., due to NR mobility—the UE data could still be transmitted/received through EUTRAN. The UE is by design aware of the current RAT being used by the device and this information can be used to decide the probability thresholds th_1 and th_2 of FIG. 10, as shown in FIG. 14. Specifically, in NSA, the price—in terms of data interruption time or user QoE—of not performing an early-sync to a cell that becomes the target cell is lower. This is because the data interruption time can be shorter due to the availability of the EUTRAN data plane. In contrast, the price is higher for the SA architecture. If the device does not perform early-sync to a cell, then it would need to sync to the cell after LTM execution before data transmission/reception can start. This would lead to data interruption time and probably compromised QoE for the user.

FIG. 14 illustrates an example procedure 1400 for RAT based threshold selection according to embodiments of the present disclosure. An embodiment of the procedure illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments for RAT based threshold selection could be used without departing from the scope of this disclosure.

In the example of FIG. 14, at block 1404 the UE determines whether a RAT type of the current RAT 1402 is SA or NSA. As such, given the knowledge of the RAT type, the device chooses the thresholds th_1 and th_2 accordingly. Specifically, if the current RAT 1402 is SA, smaller values for both th_1 and th_2 are used, whereas if the current RAT 1402 is NSA, larger values for th_1 and th_2 are used. Example values for SA would be 0.5 for th_1 and 0.2 for th_2, whereas for NSA, example values would be 0.7 for th_1 and 0.4 for th_2.

Although FIG. 14 illustrates one example of a procedure 1400 for RAT based threshold selection, various changes may be made to FIG. 14. For example, while shown as a series of steps, various steps in FIG. 14 could overlap, occur in parallel, occur in a different order, occur any number of times, be omitted, or replaced by other steps.

In another embodiment, the application throughput demand in addition to the RAT is also taken into consideration. Specifically, if the currently active application has a high throughput, then it may not be possible to satisfy the throughput requirements by the LTE and hence even in NSA architecture, smaller thresholds need to be used. The procedure to be used to take the throughput demand into consideration is shown in FIG. 15.

FIG. 15 illustrates another example procedure 1500 for RAT based threshold selection according to embodiments of the present disclosure. An embodiment of the procedure illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments for RAT based threshold selection could be used without departing from the scope of this disclosure.

In the example of FIG. 15, at block 1504 the UE determines whether a RAT type of the current RAT 1502 is SA or NSA. As such, given the knowledge of the RAT type, the device chooses the thresholds th_1 and th_2 accordingly. Specifically, if the current RAT 1502 is SA, smaller values for both th_1 and th_2 are used.

If the current RAT 1502 is NSA, and at block 1508 the application throughput demand is less than a threshold d_1 (e.g., 20 Mbps), then larger values of the thresholds are used at block 1510. Otherwise, smaller values of the thresholds are used at block 1506.

Although FIG. 15 illustrates one example of a procedure 1500 for RAT based threshold selection, various changes may be made to FIG. 15. For example, while shown as a series of steps, various steps in FIG. 15 could overlap, occur in parallel, occur in a different order, occur any number of times, be omitted, or replaced by other steps.

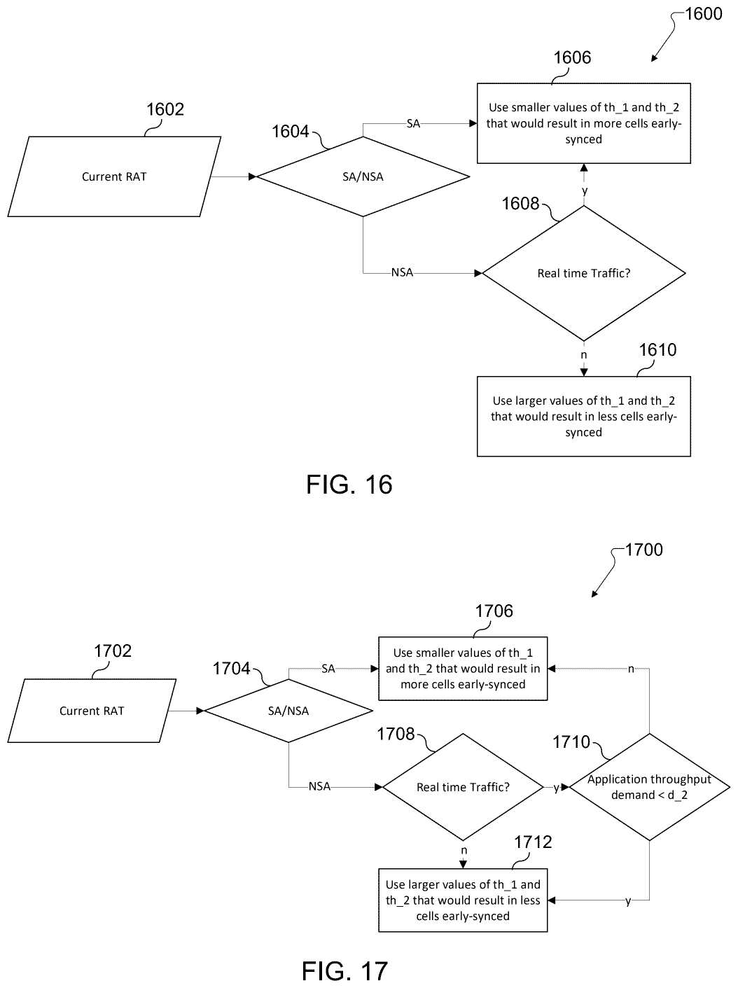

In another embodiment, the traffic type is also taken into consideration. Specifically, if the traffic is RT, smaller values of the thresholds are used, and for NRT applications, larger values of the thresholds are used. An example embodiment is shown in FIG. 16.

FIG. 16 illustrates another example procedure 1600 for RAT based threshold selection according to embodiments of the present disclosure. An embodiment of the procedure illustrated in FIG. 16 is for illustration only. One or more of the components illustrated in FIG. 16 may be implemented in specialized circuitry configured to perform the noted functions or one or more of the components may be implemented by one or more processors executing instructions to perform the noted functions. Other embodiments for RAT based threshold selection could be used without departing from the scope of this disclosure.

In the example of FIG. 16, at block 1604 the UE determines whether a RAT type the current RAT 1602 is SA or NSA. As such, given the knowledge of the RAT type, the device chooses the thresholds th_1 and th_2 accordingly. Specifically, if the current RAT 1602 is SA, smaller values for both th_1 and th_2 are used.

If the current RAT 1602 is NSA, and at block 1608 the traffic is not RT traffic, then larger values of the thresholds are used at block 1510. Otherwise, smaller values of the thresholds are used at block 1606.

Although FIG. 16 illustrates one example of a procedure 1600 for RAT based threshold selection, various changes may be made to FIG. 16. For example, while shown as a series of steps, various steps in FIG. 16 could overlap, occur in parallel, occur in a different order, occur any number of times, be omitted, or replaced by other steps.

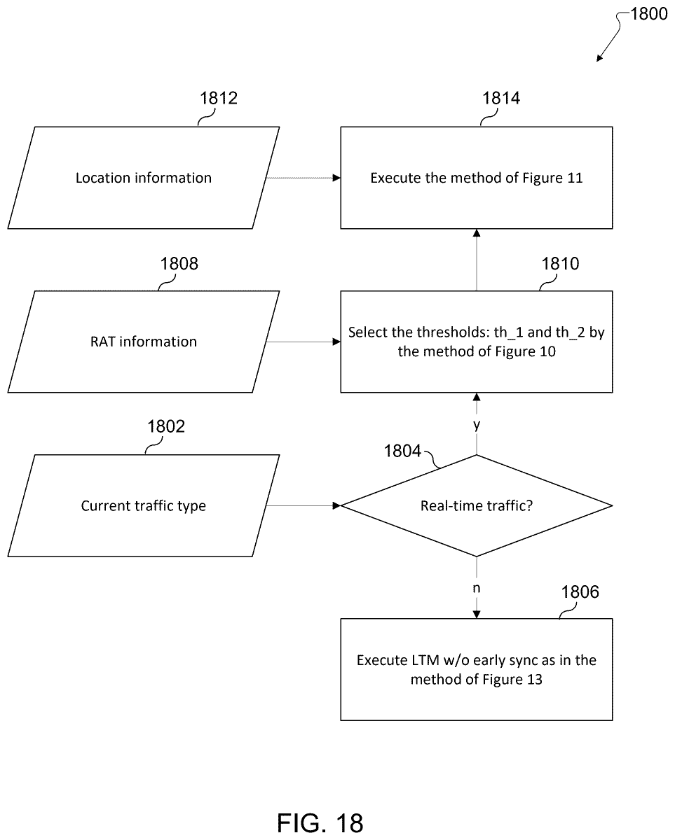

In yet another embodiment, both the traffic type and throughput demand are used. Specifically, for the NSA RAT case, smaller values of th_1 and th_2 are used, only if the traffic type is RT and the application throughput demand is higher than an application throughput demand threshold d_2 (e.g., 5 Mbps). An example embodiment is shown in FIG. 17.

FIG. 17 illustrates another example procedure 1700 for RAT based threshold selection according to embodiments of the present disclosure. An embodiment of the procedure illustrated in FIG. 17 is for illustration only. One or more of the components illustrated in FIG. 17 may be implemented in specialized circuitry configured to perform the noted functions or one or more of the components may be implemented by one or more processors executing instructions to perform the noted functions. Other embodiments for RAT based threshold selection could be used without departing from the scope of this disclosure.

In the example of FIG. 17, at block 1704 the UE determines whether the current RAT 1702 is SA or NSA. As such, given the knowledge of the RAT, the device chooses the thresholds th_1 and th_2 accordingly. Specifically, if the current RAT 1702 is SA, smaller values for both th_1 and th_2 are used.

If the current RAT 1702 is NSA, and at block 1708 the traffic is not RT traffic, then larger values of the thresholds are used at block 1712.

If the current RAT 1702 is NSA, and at block 1708 the traffic is RT traffic, if at block 1710 the application throughput demand is higher than an application throughput demand threshold d_2, then larger values of the thresholds are used at block 1712. Otherwise, smaller values of the thresholds are used at block 1706.

Although FIG. 17 illustrates one example of a procedure 1700 for RAT based threshold selection, various changes may be made to FIG. 17. For example, while shown as a series of steps, various steps in FIG. 17 could overlap, occur in parallel, occur in a different order, occur any number of times, be omitted, or replaced by other steps.

Any combination of (i) the location based early-sync decision as in FIG. 8, FIG. 9, FIG. 10, or FIG. 11, (ii) RAT based threshold selection as in FIG. 14, FIG. 15, FIG. 16 and FIG. 17, (iii) location based L1 filter design as in FIG. 12, and (iv) traffic based early-sync decision as in FIG. 13 can be used. An example embodiment jointly using the location, RAT, and traffic-type is shown in FIG. 18.

FIG. 18 illustrates an example procedure 1800 for multi-factor based candidate cell early-sync selection according to embodiments of the present disclosure. An embodiment of the procedure illustrated in FIG. 18 is for illustration only. One or more of the components illustrated in FIG. 18 may be implemented in specialized circuitry configured to perform the noted functions or one or more of the components may be implemented by one or more processors executing instructions to perform the noted functions. Other embodiments for multi-factor based candidate cell early-sync selection could be used without departing from the scope of this disclosure.

In the example of FIG. 18, at block 1804, if the current traffic type 1802 is not RT, LTM procedure is executed without early-sync at block 1806 as in the bottom leg of FIG. 13. If, however, current traffic contains RT traffic, then at block 1810 the thresholds th_1 and th_2 are selected based on RAT information 1808 according to the method of FIG. 14. Finally, at block 1814 with the location information 1812 the method of FIG. 11 is performed for LTM execution.

Although FIG. 18 illustrates one example of a procedure 1800 for multi-factor based candidate cell early-sync selection, various changes may be made to FIG. 18. For example, while shown as a series of steps, various steps in FIG. 18 could overlap, occur in parallel, occur in a different order, occur any number of times, be omitted, or replaced by other steps.

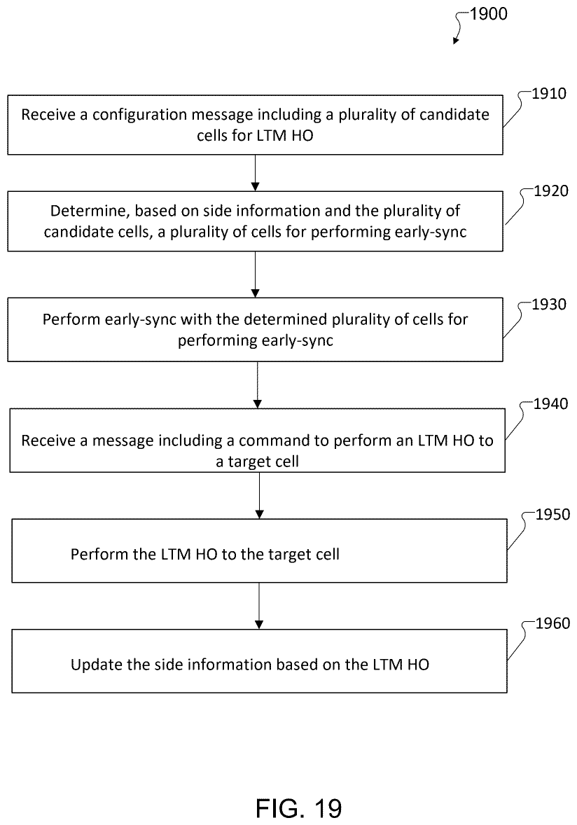

FIG. 19 illustrates a method 1900 for low layer triggered mobility with side information according to embodiments of the present disclosure. An embodiment of the method illustrated in FIG. 19 is for illustration only. One or more of the components illustrated in FIG. 19 may be implemented in specialized circuitry configured to perform the noted functions or one or more of the components may be implemented by one or more processors executing instructions to perform the noted functions. Other embodiments for low layer triggered mobility with side information could be used without departing from the scope of this disclosure.

In the example of FIG. 19, method 1900 begins at step 1910. At step 1910, a UE such as UE 116 of FIG. 1 receives a configuration message including a plurality of candidate cells for LTM HO. At step 1920, the UE determines, based on side information and the plurality of candidate cells, a plurality of cells for performing early-sync. At step 1930, The UE performs early-sync with the determined plurality of cells for performing early-sync. At step 1940, the UE receives a message including a command to perform an LTM HO to a target cell. At step 1950, the UE performs the LTM HO to the target cell. Finally, at step 1960, the UE updates the side information based on the LTM HO.

Although FIG. 19 illustrates one example of a method 1900 for low layer triggered mobility with side information, various changes may be made to FIG. 19. For example, while shown as a series of steps, various steps in FIG. 19 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to receive a configuration message including a plurality of candidate cells for low layer triggered mobility (LTM) handover (HO); and
a processor operatively coupled to the transceiver, the processor configured to:
determine, based on side information and the plurality of candidate cells, a plurality of cells for performing early-sync; and
perform early-sync with the determined plurality of cells for performing early-sync;
wherein the transceiver is further configured to receive a message including a command to perform an LTM HO to a target cell; and
wherein the processor is further configured to:
perform the LTM HO to the target cell; and
update the side information based on the LTM HO.

2. The UE of claim 1, wherein:
the side information includes:
a location of the UE; and
past ping-pong information, and the processor is further configured to:
determine whether an average number of past ping-pongs associated with the location exceed a ping-pong threshold;
if the average number of past ping-pongs associated with the location exceed the ping-pong threshold, configure the UE to use a layer 1 (L1) filter that provides more averaging; and
if the average number of past ping-pongs associated with the location fails to exceed the ping-pong threshold, configure the UE to use a L1 filter that provides less averaging.

3. The UE of claim 1, wherein:
the side information includes a traffic type; and
to determine the plurality of cells for performing early-sync:
if the traffic type includes real time traffic, the processor is further configured to include at least one candidate cell in the plurality of cells for performing early-sync; and
if the traffic type does not include real time traffic, the processor is further configured to exclude the candidate cells from the plurality of cells for performing early-sync.

4. The UE of claim 1, wherein:
the side information includes:
a location of the UE,
past candidate cells associated with the location; and
past target cells associated with the location; and
to determine the plurality of cells for performing early-sync, the processor is further configured to:
determine whether all the candidate cells are past candidate cells associated with the location;
if all the candidate cells are past candidate cells associated with the location, include past target cells associated with the location in the plurality of cells for performing early-sync; and
if all the candidate cells are not past candidate cells associated with the location, include past target cells associated with the location and new candidate cells from the candidate cells in the plurality of cells for performing early-sync.

5. The UE of claim 4, wherein to perform early-sync with the determined plurality of cells for performing early-sync, the processor is further configured to:
perform downlink (DL) early-sync with all of the candidate cells; and
perform uplink (UL) early-sync with the determined plurality of cells for performing early-sync.

6. The UE of claim 4, wherein to perform early-sync with the determined plurality of cells for performing early-sync, the processor is further configured to:
perform uplink (UL) early-sync with past target cells included in the plurality of cells for performing early-sync with a target/candidate ratio exceeding a second threshold, the second threshold being higher than a first threshold;
perform downlink (DL) early-sync with past target cells included in the plurality of cells for performing early-sync with a target/candidate ratio exceeding the first threshold; and
refrain from performing early-sync with past target cells included in the plurality of cells for performing early-sync with a target/candidate ratio failing to exceed the first threshold.

7. The UE of claim 6, wherein:
the side information includes a radio access technology (RAT) type;
if the RAT type is standalone (SA), the processor is further configured to:
set the first threshold to a first value; and
set the second threshold to a second value; and
if the RAT type is non-standalone (NSA), the processor is further configured to:
set the first threshold to a third value, the third value being higher than the first value; and
set the second threshold to a fourth value, the fourth value being higher than the second value.

8. The UE of claim 6, wherein:
the side information includes:
a radio access technology (RAT) type; and
an application throughput demand;
if the RAT type is standalone (SA) or if the application throughput demand is lower than an application throughput demand threshold, the processor if further configured to:
set the first threshold to a first value; and
set the second threshold to a second value; and
if the RAT type is non-standalone (NSA) and the application throughput demand is greater than or equal to the application throughput demand threshold, the processor is further configured to:
set the first threshold to a third value, the third value being higher than the first value; and
set the second threshold to a fourth value, the fourth value being higher than the second value.

9. The UE of claim 6, wherein:
the side information includes:
a radio access technology (RAT) type; and
a traffic type;
if the RAT type is standalone (SA) or if the traffic type is real time traffic (RT), the processor is further configured to:
set the first threshold to a first value; and
set the second threshold to a second value; and
if the RAT type is non-standalone (NSA) and the traffic type is non-real time traffic (NRT), the processor is further configured to:
set the first threshold to a third value, the third value being higher than the first value; and
set the second threshold to a fourth value, the fourth value being higher than the second value.

10. The UE of claim 6, wherein:
the side information includes:
a radio access technology (RAT) type;
an application throughput demand; and
a traffic type;
if the RAT type is standalone (SA) traffic (RT), the processor if further configured to:
set the first threshold to a first value; and
set the second threshold to a second value;
if the RAT type is non-standalone (NSA) and the traffic type is non-real time traffic (NRT), the processor is further configured to:
set the first threshold to a third value, the third value being higher than the first value; and
set the second threshold to a fourth value, the fourth value being higher than the second value; and
if the RAT type is non-standalone (NSA) and the traffic type is real time traffic (RT), the processor is further configured to:
if the application throughput demand is lower than an application throughput demand threshold:
set the first threshold to the third value; and
set the second threshold the fourth value; and
if the application throughput demand is greater than or equal to the application throughput demand threshold:
set the first threshold to the first value; and
set the second threshold to the second value.

11. A method of operating a user equipment (UE), the method comprising:
receiving a configuration message including a plurality of candidate cells for low layer triggered mobility (LTM) handover (HO);
determining, based on side information and the plurality of candidate cells, a plurality of cells for performing early-sync;
performing early-sync with the determined plurality of cells for performing early-sync;
receiving a message including a command to perform an LTM HO to a target cell;
performing the LTM HO to the target cell; and
updating the side information based on the LTM HO.

12. The method of claim 11, wherein:
the side information includes:
a location of the UE; and
past ping-pong information, and
the method further includes:
determining whether an average number of past ping-pongs associated with the location exceed a ping-pong threshold;
if the average number of past ping-pongs associated with the location exceed the ping-pong threshold, configuring the UE to use a layer 1 (L1) filter that provides more averaging; and
if the average number of past ping-pongs associated with the location fails to exceed the ping-pong threshold, configuring the UE to use a L1 filter that provides less averaging.

13. The method of claim 11, wherein:
the side information includes a traffic type; and
determining the plurality of cells for performing early-sync comprises:
if the traffic type includes real time traffic, including at least one candidate cell in the plurality of cells for performing early-sync; and
if the traffic type does not include real time traffic, excluding the candidate cells from the plurality of cells for performing early-sync.

14. The method of claim 11, wherein:
the side information includes:
a location of the UE,
past candidate cells associated with the location; and
past target cells associated with the location; and
determining the plurality of cells for performing early-sync comprises:
determining whether all the candidate cells are past candidate cells associated with the location;
if all the candidate cells are past candidate cells associated with the location, including past target cells associated with the location in the plurality of cells for performing early-sync; and
if all the candidate cells are not past candidate cells associated with the location, including past target cells associated with the location and new candidate cells from the candidate cells in the plurality of cells for performing early-sync.

15. The method of claim 14, wherein performing early-sync with the determined plurality of cells for performing early-sync, comprises:
performing downlink (DL) early-sync with all of the candidate cells; and
performing uplink (UL) early-sync with the determined plurality of cells for performing early-sync.

16. The method of claim 14, performing early-sync with the determined plurality of cells for performing early-sync, comprises:
performing uplink (UL) early-sync with past target cells included in the plurality of cells for performing early-sync with a target/candidate ratio exceeding a second threshold, the second threshold being higher than a first threshold;
performing downlink (DL) early-sync with past target cells included in the plurality of cells for performing early-sync with a target/candidate ratio exceeding the first threshold; and
refraining from performing early-sync with past target cells included in the plurality of cells for performing early-sync with a target/candidate ratio failing to exceed the first threshold.

17. The method of claim 16, wherein:
the side information includes a radio access technology (RAT) type;
if the RAT type is standalone (SA), the method further includes:
setting the first threshold to a first value; and
setting the second threshold to a second value; and
if the RAT type is non-standalone (NSA), the method further includes:
setting the first threshold to a third value, the third value being higher than the first value; and
setting the second threshold to a fourth value, the fourth value being higher than the second value.

18. The method of claim 16, wherein:
the side information includes:
a radio access technology (RAT) type; and
an application throughput demand;
if the RAT type is standalone (SA) or if the application throughput demand is lower than an application throughput demand threshold, the method further includes:
setting the first threshold to a first value; and
setting the second threshold to a second value; and
if the RAT type is non-standalone (NSA) and the application throughput demand is greater than or equal to the application throughput demand threshold, the method further includes:
setting the first threshold to a third value, the third value being higher than the first value; and
setting the second threshold to a fourth value, the fourth value being higher than the second value.

19. The UE of claim 16, wherein:
the side information includes:
a radio access technology (RAT) type; and
a traffic type;
if the RAT type is standalone (SA) or if the traffic type is real time traffic (RT), the method further includes:
setting the first threshold to a first value; and
setting the second threshold to a second value; and
if the RAT type is non-standalone (NSA) and the traffic type is non-real time traffic (NRT), the method further includes:
setting the first threshold to a third value, the third value being higher than the first value; and
setting the second threshold to a fourth value, the fourth value being higher than the second value.

20. The method of claim 16, wherein:
the side information includes:
a radio access technology (RAT) type;
an application throughput demand; and
a traffic type;
if the RAT type is standalone (SA) traffic (RT), the method further includes:
setting the first threshold to a first value; and
setting the second threshold to a second value;
if the RAT type is non-standalone (NSA) and the traffic type is non-real time traffic (NRT), the method further includes:
setting the first threshold to a third value, the third value being higher than the first value; and
setting the second threshold to a fourth value, the fourth value being higher than the second value; and
if the RAT type is non-standalone (NSA) and the traffic type is real time traffic (RT), the method further includes:
if the application throughput demand is lower than an application throughput demand threshold:
setting the first threshold to the third value; and
setting the second threshold the fourth value; and
if the application throughput demand is greater than or equal to the application throughput demand threshold:
setting the first threshold to the first value; and
setting the second threshold to the second value.
